(19) United States
(12) Patent Application Publication
(10) Pub. No.: US 2025/0175950 A1
(43) Pub. Date: May 29, 2025

(54) COMMUNICATION MANAGEMENT DEVICE AND RADIO RESOURCE PREDICTION METHOD

(71) Applicant: Fujitsu Limited, Kawasaki-shi (JP)

(72) Inventors: Takuya OMACHI, Fukuoka (JP); Erika SUZUKI, Kawasaki (JP); Yasunari IZAWA, Sagamihara (JP); Kousuke IEMURA, Kawasaki (JP); Keisuke ASAKURA, Meguro (JP); Yoshino YOKARYO, Chofu (JP)

(73) Assignee: Fujitsu Limited, Kawasaki-shi (JP)

(21) Appl. No.: 18/918,151

(22) Filed: Oct. 17, 2024

(30) Foreign Application Priority Data
Nov. 28, 2023 (JP) 2023-200600

(51) Int. Cl. H04W 72/04; H04W 16/18; H04W 64/00

(52) U.S. Cl. CPC H04W 72/04; H04W 16/18; H04W 64/003

(57) ABSTRACT

Communication management device includes a processor circuitry and is used in radio communication system forming cells. The processor circuitry calculates, for each partial area, the number of terminal devices in the partial area to obtain first result. The processor circuitry calculates, for each partial area, the number of cells covering the partial area to obtain second result. The processor circuitry calculates, for each partial area, the number of terminal devices allocated to one cell based on the first and second results to obtain third result. The processor circuitry calculates, for each cell, amount of radio resources to be provided to each partial area in the cell based on usage amount of radio resources in the cell and the third result to obtain fourth result. The processor circuitry calculates, for each partial area, amount of radio resources to be provided to the partial area based on the amount of radio resources indicated by the fourth result.

### CROSS-REFERENCE TO RELATED APPLICATION

This application is based upon and claims the benefit of priority of the prior Japanese Patent Application No. 2023-200600, filed on Nov. 28, 2023, the entire contents of which are incorporated herein by reference.

### FIELD

The embodiments discussed herein are related to a system for managing radio communication and a method for predicting a usage amount of radio resources.

### BACKGROUND

Cell design for radio communication is one of important techniques for efficiently providing a service. In the cell design, based on a traffic amount of each cell, disposition of base stations is determined and an operational status of each base station is determined. For example, in an area where connection is difficult, it is required to provide an additional base station. In an area where a plurality of cells overlap each other, it is preferable to stop one or a plurality of base stations to reduce power consumption in a time period during which a traffic amount is small. A method for assisting area design of radio communication has been suggested (for example, International Publication Pamphlet No. WO2023/275922 and International Publication Pamphlet No. WO2023/275928).

In recent years, a plurality of cells having different frequency bands overlap each other, cell design become complicated. In post-5G communication or the like, in a case where a high frequency band is used, a coverage of each cell is narrow. For this reason, it is required to detect a place where locally large traffic occurs.

### SUMMARY

According to an aspect of the embodiments, a communication management device is used in a radio communication system forming a plurality of cells. The communication management device includes a processor circuitry configured to calculate, for each of a plurality of partial areas obtained by dividing a designated area, the number of terminal devices positioned in the partial area to obtain a first calculation result, calculate, for each of the plurality of partial areas, the number of cells covering the partial area to obtain a second calculation result, calculate, for each of the plurality of partial areas, the number of terminal devices allocated to one cell based on calculation result and the second calculation the first result to obtain a third calculation result, calculate, for each of the plurality of cells, an amount of radio resources to be provided to each partial area in the cell based on a usage amount of radio resources in the cell and the third calculation result to obtain a fourth calculation result, and calculate, for each of the plurality of partial areas, an amount of radio resources to be provided to the partial area based on the amount of radio resources indicated by the fourth calculation result.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 illustrates an example of a radio communication system according to an embodiment of the present disclosure;

FIG. 2 illustrates an example of a functional configuration of a communication management device according to the embodiment;

FIG. 3 is a diagram illustrating a prediction target area and partial areas;

FIG. 4 illustrates an example of a calculation result by a mesh-base number-of-UE calculator;

FIGS. 5A and 5B illustrate an example of a calculation result by a mesh-base number-of-cell calculator;

FIG. 6 illustrates an example of the number of terminal devices allocated to one cell for each partial area;

FIG. 7 illustrates an example of the number of terminal devices allocated to each cell;

FIGS. 8 and 9 illustrate examples of a usage amount of radio resource of each partial area in each cell;

FIG. 10 illustrates an example of prediction of a radio resource usage amount in each partial area;

FIG. 11 is a flowchart illustrating an example of a radio resource prediction method according to the embodiment; and

FIG. 12 illustrates an example of a hardware configuration of the communication management device.

### DESCRIPTION OF EMBODIMENTS

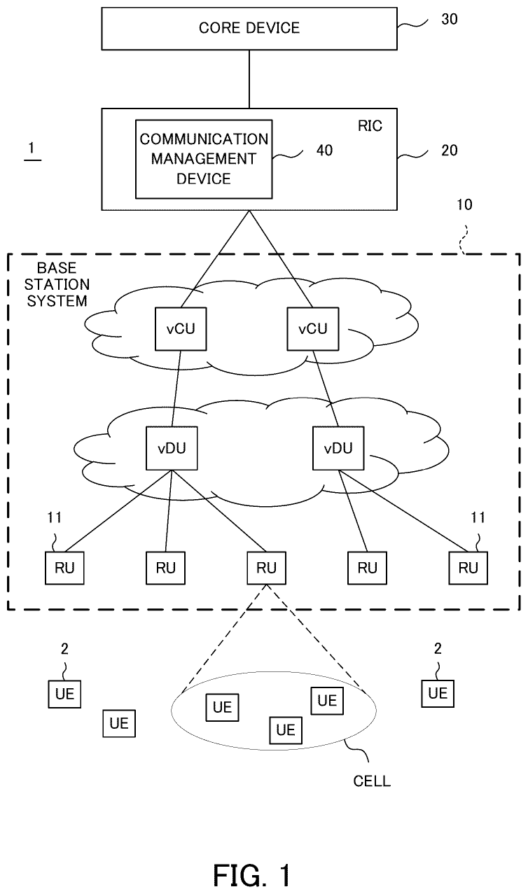

FIG. 1 illustrates an example of a radio communication system according to an embodiment of the present disclosure. In this example, as illustrated in FIG. 1, a radio communication system 1 according to the embodiment includes a base station system 10, a radio access network (RAN) intelligence controller (RIC) 20, and a core device 30. The radio communication system 1 is not particularly limited, and provides, for example, a 5G service.

In this example, the base station system 10 is a virtualized base station and is configured with a plurality of computers. The plurality of computers may be provided on a cloud. That is, the base station system 10 may be implemented by cloud computing. The base station system 10 includes software (vCU and vDU) describing the operation of the base station. A virtual Central Unit (vCU) provides functions of a CU, and a virtual Distributed Unit (vDU) provides functions of a DU.

The base station system 10 includes a plurality of radio units (RU) 11. Each radio unit 11 includes a radio transceiver and an antenna, and forms a cell under the control of corresponding vCU/vDU. The cell represents a range (that is, a coverage) in which the radio unit 11 can communicate. The radio unit 11 communicates with a terminal device (User Equipment (UE)) 2 located in the cell. Each radio unit 11 may form a plurality of cells. Each cell may be formed to overlap at least a part of one or a plurality of other cells.

The RIC 20 is configured with one or a plurality of computers and controls optimization of resources and automatic operation of a radio access network (that is, RAN). The RIC 20 may include a Non-Real-Time RIC and a Near-Real-Time RIC. The core device 30 connects the base station system 10 and the RIC 20 to a core network.

In the radio communication system 1 of the above-described configuration, a communication management device 40 according to the embodiment is implemented, for example, in the RIC 20. Here, in a case where the RIC 20 includes the Non-Real-Time RIC and the Near-Real-Time RIC, the communication management device 40 is configured with the Non-Real-Time RIC.

The communication management device 40 acquires Configuration Management (CM) data and Performance Management (PM) data from the base station system 10. The CM data includes information pertaining to the configuration of the base station system 10, information for managing radio resources, information for managing station data, information pertaining software update, and the like. Accordingly, the communication management device 40 can calculate an area that is covered by each cell provided by the base station system 10, based on the CM data. The PM data includes information representing traffic of each network element in the base station system 10, information representing a radio resource usage, and the like.

The communication management device 40 detects a position of each terminal device 2. The position of the terminal device 2 is not particularly limited, and is calculated, for example, using Minimization of Drive Test (MDT) data. MDT is one of techniques for collecting Quality of Experience (QoE) information, and each terminal device notifies the base station of a position and a cause of occurrence of an event such as radio link disconnection or handover failure during communication. Here, the MDT data is collected in a specified cycle (for example, at intervals of ten minutes) by a communication carrier. The MDT is described, for example, in 3GPP TS 37.320.

The communication management device 40 may detect the position of the terminal device 2 by other methods. For example, the communication management device 40 may detect the position of the terminal device 2 by the following method. In addition, the communication management device 40 may detect the position of the terminal device 2 using Global Positioning System (GPS) data.
Location Services (3GPP TS 23.273)
Positioning Services (3GPP TS 22.261)
OTDOA positioning (3GPP TS 36.305)

The communication management device 40 predicts a radio resource usage in each cell (or radio traffic of each cell) based on the CM data, the PM data, and positional information of the terminal device 2. In addition, the communication management device 40 predicts a radio resource usage for each of a plurality of partial areas obtained by dividing a designated prediction target area. In this case, the communication management device 40 predicts a radio resource usage based on past CM/PM data and position data. For example, a radio resource usage is predicted for each time period (0:00 to 6:00, 6:00 to 12:00, 12:00 to 18:00, 18:00 to 24:00, and the like) in a day. Alternatively, a radio resource usage may be predicted for each day of week (Monday to Friday, Saturday and Sunday, and the like).

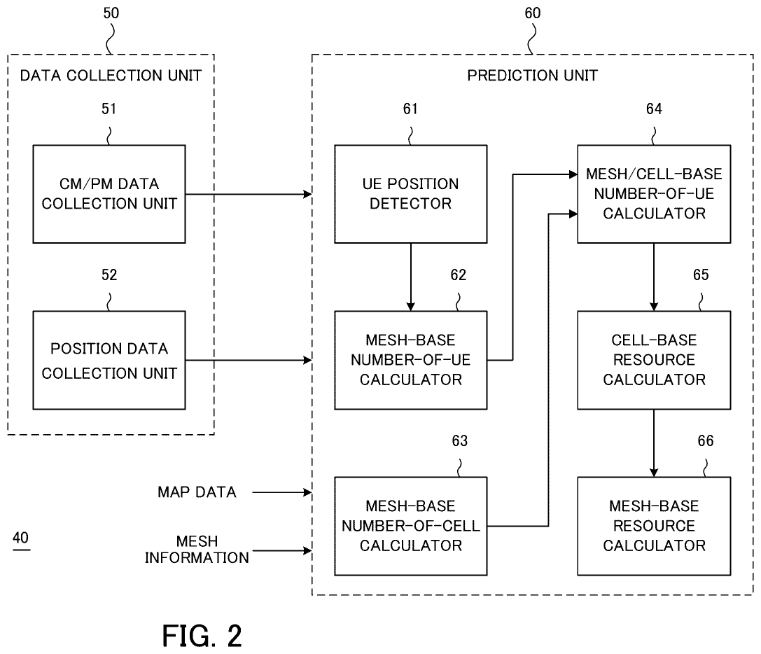

FIG. 2 illustrates an example of a functional configuration of the communication management device 40 according to the embodiment. The communication management device 40 includes a data collection unit 50 and a prediction unit 60. Note that the communication management device 40 may further includes other functions not illustrated in FIG. 2.

The data collection unit 50 includes a CM/PM data collection unit 51 and a position data collection unit 52. The CM/PM data collection unit 51 collects CM data and PM data from the base station system 10 illustrated in FIG. 1. As described above, the CM data includes information pertaining to the configuration of the base station system 10, information for managing radio resources, information for managing station data, information pertaining to software update, and the like. Accordingly, the communication management device 40 can calculate an area that is covered by each cell formed by the base station system 10, based on the CM data. As described above, the PM data includes information representing the traffic of each network element in the base station system 10, information representing the radio resource usage, and the like. The CM/PM data collection unit 51 collects the CM data and the PM data in a specified cycle over a specified duration. For example, the CM/PM data collection unit 51 may collect the CM data and the PM data at intervals of ten minutes over a week. The CM data and the PM data collected by the CM/PM data collection unit 51 are stored in a memory (not illustrated).

The position data collection unit 52 collects position data representing the position of the terminal device 2. In this case, the position data collection unit 52 collects position data in a specified cycle over a specified duration. For example, the position data collection unit 52 may collect position data at intervals of ten minutes over a week. The position data collection unit 52 may collect position data of all terminal devices 2 in a communication area of the base station system 10 or may collect position data of some terminal devices 2 in the communication area of the base station system 10. For example, the position data collection unit 52 collects MDT data of the terminal device 2. Here, MDT notifies the base station of the position of the terminal device 2 in which an event such as radio link disconnection or handover failure occurs. Accordingly, the MDT data represents the positions of some terminal devices 2 in the communication area of the base station system 10. The position data collected by the position data collection unit 52 is stored in the memory (not illustrated).

The prediction unit 60 includes a UE position detector 61, a mesh-base number-of-UE calculator (first calculation unit) 62, a mesh-base number-of-cell calculator (second calculation unit) 63, a mesh/cell-base number-of-UE calculator (third calculation unit) 64, a cell-base resource calculator (fourth calculation unit) 65, and a mesh-base resource calculator (fifth calculation unit) 66. The prediction unit 60 predicts a usage amount of radio resources (or radio traffic) based on the CM data, the PM data, and the position data collected by the data collection unit 50.

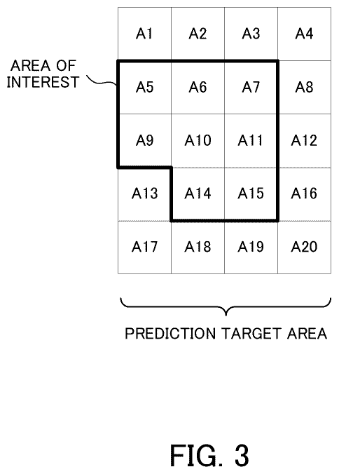

In addition to the CM data, the PM data, and the position data, map data and mesh information are given to the prediction unit 60. The map data represents the topography or the like of the communication area of the base station system 10. The mesh information defines a mesh for dividing the prediction target area into a plurality of partial areas. The prediction target area represents an area where the communication management device 40 predicts the usage amount of the radio resources. In this example, the partial area is a square. In this case, the mesh divides the prediction target area into a plurality of squares. In the example illustrated in FIG. 3, the prediction target area is divided into 20 partial areas A1 to A20. That is, the plurality of partial areas configure the mesh. The plurality of partial areas have the same shape. The size of each partial area is not particularly limited, and is, for example, 100×100 meters. The mesh represented by the mesh information is superimposed on the map data. In the following description, for only the partial areas A5 to A7, A9 to A11, A14, and A15 in an area of interest surrounded by a bold line in FIG. 3, a calculation result of the prediction unit 60 may be denoted.

The prediction unit 60 predicts a usage amount of radio resources to be provided by the base station system 10, based on the CM data, the PM data, and the position data which are collected in a specified cycle over a specified duration (for example, for a week). In this case, the prediction unit 60 may predict a usage amount of radio resources for each of a plurality of time periods. For example, a usage amount of radio resources is predicted for each of 0:00 to 1:00, 1:00 to 2:00, . . . , and 23:00 to 24:00. When a traffic amount depends on the day of week, the prediction unit 60 may predict a usage amount of radio resources for each day of week.

The UE position detector 61 detects the position of each terminal device 2 based on the position data collected by the data collection unit 50. Here, as described above, the position data is collected in a specified duration. Accordingly, the position of each terminal device 2 detected by the UE position detector 61 is recorded in association with a collection time of the position data.

The mesh-base number-of-UE calculator 62 calculates the number of terminal devices 2 positioned in each partial area based on the map data, the mesh information, and the position of each terminal device 2 detected by the UE position detector 61. Here, a position and a size of each partial area are defined by the map data and the mesh information. The position of each terminal device 2 is detected by the UE position detector 61. Accordingly, the mesh-base number-of-UE calculator 62 can calculate the number of terminal devices 2 positioned in each partial area. Furthermore, the mesh-base number-of-UE calculator 62 sequentially calculates the number of terminal devices 2 positioned in each partial area for a plurality of time periods.

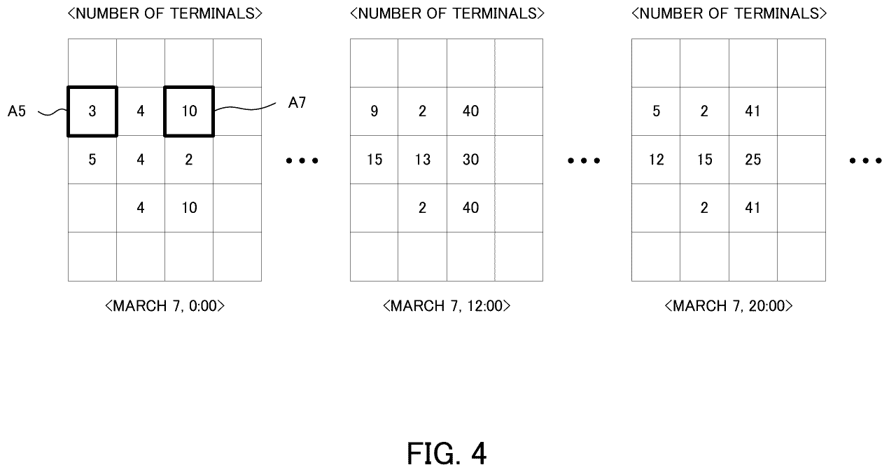

FIG. 4 illustrates an example of a calculation result by the mesh-base number-of-UE calculator 62. In this example, for example, at 0:00 on March 7, three terminal devices 2 are positioned in the partial area A5, and ten terminal devices 2 are positioned in the partial area A7. “0:00 on March 7” may mean a period of time (for example, 0:00 to 1:00 on March 7) including 0:00 on March 7. In this case, the number of terminal devices 2 represents the number of terminal devices 2 detected in the period of time.

In a case where the MDT data is used as position data, the number of terminal devices 2 calculated for each partial area may decrease. For example, even in a case where one or a plurality of terminal devices 2 are positioned in a certain partial area, if link disconnection or handover failure does not occur, the terminal device 2 may not be detected. Accordingly, the mesh-base number-of-UE calculator 62 may determine the number of terminal devices 2 positioned in each partial area using complementary process described below.

For example, the number of terminal devices 2 positioned in one partial area (hereinafter, referred to as a partial area Z) in the prediction target area in a time period TZ within a data collection duration is obtained by the following complementary process.

Number of terminal devices 2=(Z1/Z2)×Z3
Z1: a sum of values calculated for the partial area Z (in a case where position data is collected at intervals of ten minutes, since 1008 sets of position data are obtained for the data collection duration of a week, a sum of 1008 values is calculated) based on position data acquired in each data collection time period of the data collection duration (for example, for a week)
Z2: a sum of values calculated for the entire prediction target area based on position data acquired in each data collection time period of the data collection duration
Z3: a value calculated for the entire prediction target area based on position data acquired in the time period TZ

For example, it is assumed that 21 is 3, 22 is 10000, and Z3 is 300. In this case, the number of terminal devices 2 positioned in the partial area Z in the time period TZ is 0.09. The above-described complementary process may be executed for all partial areas or may be executed only for partial areas where the calculated number of terminal devices 2 is zero.

The mesh-base number-of-cell calculator 63 calculates the number of cells covering each partial area. Here, a radio wave range of each cell is known from the CM data acquired from the base station system 10. Alternatively, the mesh-base number-of-cell calculator 63 may determine a radio wave range of each cell by measurement.

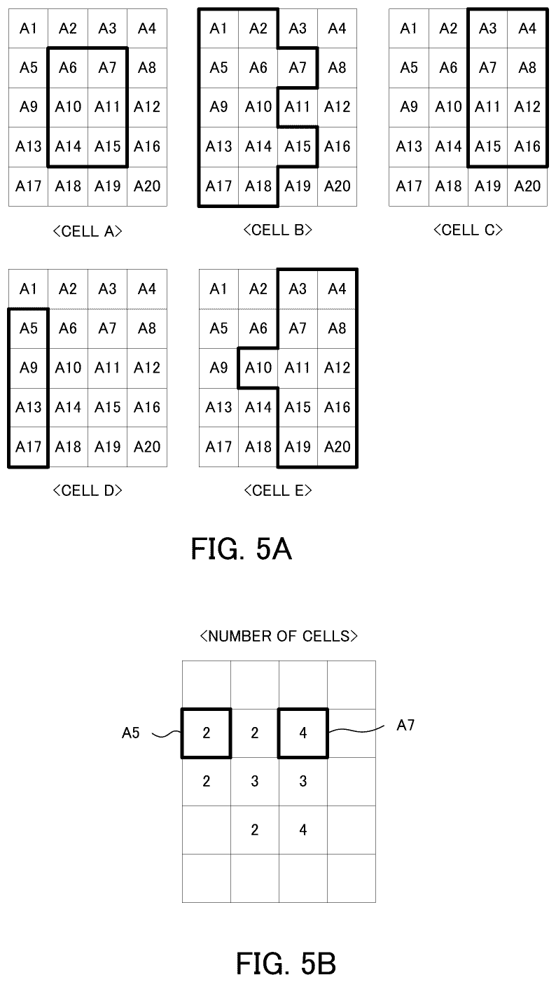

In this example, five cells (cells A to E) illustrated in FIG. 5A are formed for the prediction target area by the base station system 10. The radio wave range of the cell represents, for example, an area where a reception level of radio wave transmitted from the base station is higher than a specified threshold. Alternatively, the radio wave range of the cell represents an area where communication with the base station can be performed.

In this example, the radio wave range of the cell A covers the partial areas A6, A7, A10, A11, A14, and A15. The radio wave range of the cell B covers the partial areas A1, A2, A5 to A7, A9, A10, A13 to A15, A17, and A18. The radio wave range of the cell C covers the partial areas A3, A4, A7, A8, A11, A12, A15, and A16. The radio wave range of the cell D covers the partial areas A5, A9, A13, and A17. The radio wave range of the cell E covers the partial areas A3, A4, A7, A8, A10 to A12, A15, A16, A19, and A20.

The mesh-base number-of-cell calculator 63 counts, for each partial area, the number of cells covering the partial area. For example, the partial area A5 is covered by the cell B and the cell D. Accordingly, the number of cells covering the partial area A5 is “two”. The partial area A7 is covered by the cell A, the cell B, the cell C, and the cell E. Accordingly, the number of cells covering the partial area A7 is “four”. Similarly, as illustrated in FIG. 5B, the mesh-base number-of-cell calculator 63 counts, for each partial area, the number of cells covering the partial area.

The mesh/cell-base number-of-UE calculator 64 calculates, for each partial area, the number of terminal devices 2 allocated to one cell. Specifically, the number of terminal devices 2 to which one cell should provide the radio resources is calculated. Here, as described with reference to FIG. 4, the number of terminal devices 2 positioned in each partial area is calculated by mesh-base number-of-UE calculator 62. Furthermore, as described with reference to FIGS. 5A and 5B, the number of cells covering each partial area is calculated by the mesh-base number-of-cell calculator 63. Accordingly, the mesh/cell-base number-of-UE calculator 64 can calculate, for each partial area, the number of terminal devices 2 allocated to one cell by dividing a calculation result (that is, the number of terminal devices 2) of the mesh-base number-of-UE calculator 62 by a calculation result (that is, the number of cells) of the mesh-base number-of-cell calculator 63. Alternatively, the number of terminal devices 2 allocated to one cell may be determined with reference to a table for determining the number of terminal devices 2 allocated to one cell based on the calculation result (that is, the number of terminal devices 2) of the mesh-base number-of-UE calculator 62 and the calculation result (that is, the number of cells) of the mesh-base number-of-cell calculator 63.

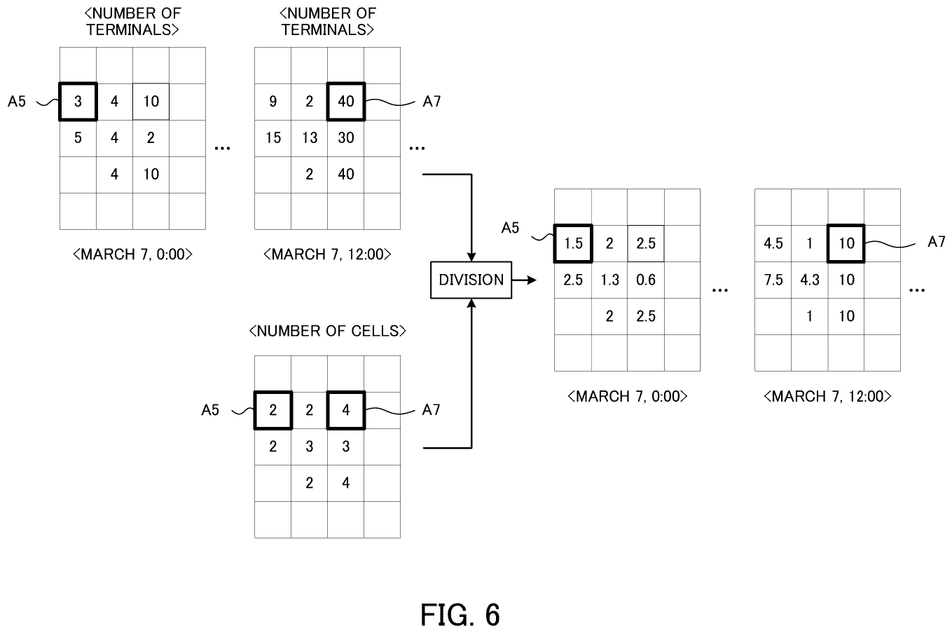

In a case illustrated in FIG. 6, for example, three terminal devices 2 are positioned in the partial area A5 from 0:00 to 1:00 on March 7. On the other hand, the partial area A5 is covered by two cells (in the example illustrated in FIG. 5A, the cell B and the cell D). In this case, the terminal devices 2 positioned in the partial area A5 use radio resources provided by the cell B or the cell D. Accordingly, in the partial area A5, an average value of the number of terminal devices 2 allocated to one cell is 1.5. From 12:00 to 13:00 on March 7, 40 terminal devices 2 are positioned in the partial area A7. On the other hand, the partial area A7 is covered by four cells (in the example illustrated in FIG. 5A, the cell A, the cell B, the cell C, and the cell E). In this case, the terminal devices 2 positioned in the partial area A7 use the radio resources provided by the cell A, the cell B, the cell C, or the cell E. Accordingly, in the partial area A7, an average value of the number of terminal devices 2 allocated to one cell is 10.

Subsequently, the mesh/cell-base number-of-UE calculator 64 calculates the number of terminal devices 2 allocated to each cell. Specifically, the number of terminal devices 2 to which each cell should provide the radio resources is calculated. Here, the number of terminal devices 2 allocated to one cell for each partial area is already calculated. Accordingly, the numbers of terminal devices 2 allocated to one cell in partial areas covered by a target cell are totaled to obtain the number of terminal devices 2 allocated to the target cell.

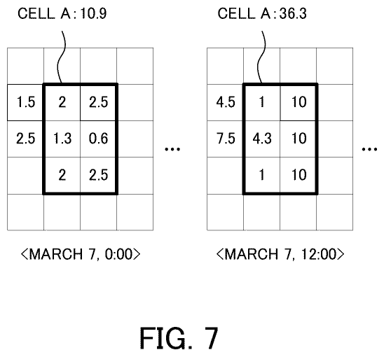

For example, as illustrated in FIG. 5A, the cell A covers the partial areas A6, A7, A10, A11, A14, and A15. Accordingly, as illustrated in FIG. 7, the number of terminal devices 2 allocated to the cell A is obtained by adding the number of terminal devices 2 allocated to each of the partial areas A6, A7, A10, A11, A14, and A15.

In this example, from 0:00 to 1:00 on March 7, the numbers of terminal devices 2 allocated to one cell in the partial areas A6, A7, A10, A11, A14, and A15 are 2, 2.5, 1.3, 0.6, 2, and 2.5, respectively. Accordingly, the number of terminal devices 2 allocated to the cell A in this time period is 10.9. Furthermore, from 12:00 to 13:00 on March 7, the numbers of terminal devices 2 allocated to one cell in the partial areas A6, A7, A10, A11, A14, and A15 are 1, 10, 4.3, 10, 1, and 10, respectively. Accordingly, the number of terminal devices 2 allocated to the cell A in this time period is 36.3. Similarly, the mesh/cell-base number-of-UE calculator 64 calculates the number of terminal devices 2 allocated to each cell for a plurality of time periods of the data collection duration.

The cell-base resource calculator 65 calculates (or predicts) an amount of radio resources to be provided to each partial area for each cell. Here, the usage amount of the radio resource in each cell is represented by the PM data notified from the base station system 10. Alternatively, the usage amount of the radio resources in each cell can be calculated based on the PM data notified from the base station system 10. As described with reference to FIGS. 6 and 7, a proportion of the number of terminal devices 2 positioned in the partial areas covered by each cell is calculated by the mesh/cell-base number-of-UE calculator 64. Accordingly, it is possible to calculate the amount of radio resources to be provided to each partial area for each cell based on such information.

For example, it is assumed that a bandwidth of radio communication of the cell A is 20 MHz. It is assumed that, from 0:00 to 1:00 on March 7, an average usage rate of the radio resources in the cell A is 20 percent. That is, it is assumed that, in this time period, an average usage amount of the radio resource in the cell A is 4 MHZ. This information is obtained, for example, based on the PM data. On the other hand, the proportion of the numbers of terminal devices 2 positioned in the partial areas (A6, A7, A10, A11, A14, and A15) covered by the cell A is “2:2.5:1.3:0.6:2:2.5” as illustrated in FIG. 7.

In this case, “4 MHz” is distributed to the partial areas in the above-described proportion, so that the amount of radio resources to be provided to each partial area is calculated. For example, an amount R6 of radio resources to be provided to the partial area A6 is calculated by the following expression.

$$R 6 = ( 2 / 10.9 ) \times 4 = 0.74 [ MHz ]$$

Furthermore, an amount R7 of radio resources to be provided to the partial area A7 is calculated by the following expression.

$$R 7 = ( 2.5 / 10.9 ) \times 4 = 0.93 [ MHz ]$$

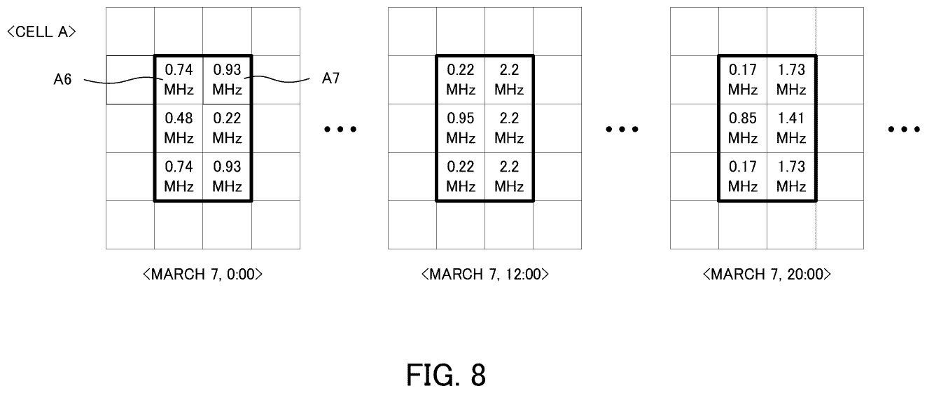

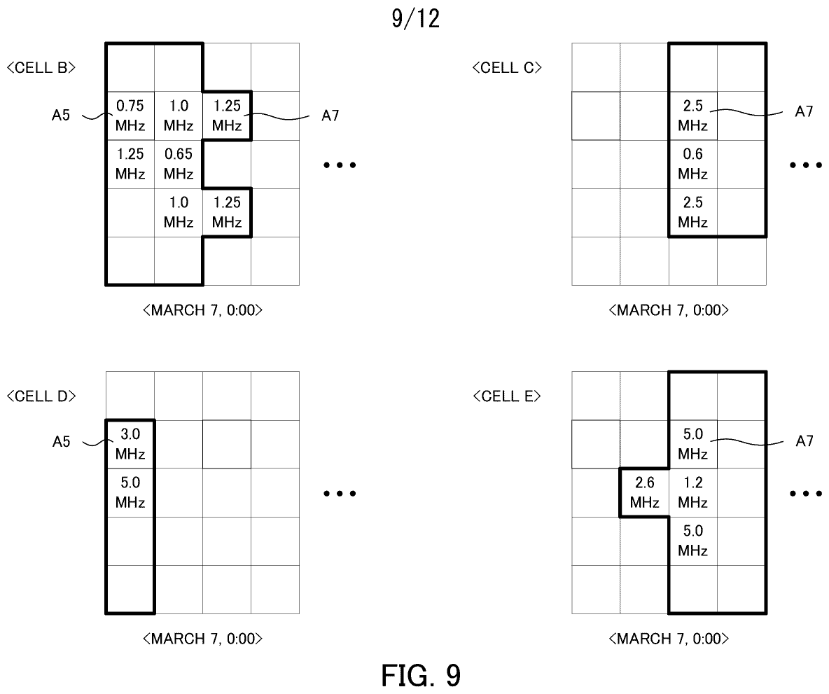

Similarly, as illustrated in FIG. 8, an amount of radio resources to be provided is also calculated for other partial areas A10, A11, A14, and A15. In addition, as illustrated in FIG. 9, an amount of radio resources to be provided is also calculated for each partial area in other cells (that is, the cell B to the cell E). In the example illustrated in FIGS. 8 and 9, the calculation result is denoted only for the partial areas A5 to A7, A9 to A11, A14, and A15 in the area of interest surrounded by the bold line in FIG. 3.

The mesh-base resource calculator 66 calculates (or predicts) a total amount of radio resources to be provided to the partial areas in consideration of superimposition of cells. Here, the amount of radio resources to be provided to each cell is calculated by the cell-base resource calculator 65. Accordingly, the total amount of the radio resources to be provided to the partial areas is calculated by adding (totalizing) the amount of radio resources to be provided to each cell for each partial area.

For example, the partial area A5 is covered by the cell B and the cell D. Here, as illustrated in FIG. 9, from 0:00 to 1:00 on March 7, the terminal devices 2 in the partial area A5 are provided with radio resources of 0.75 MHz from the cell B and are provided with radio resources of 3 MHz from the cell D. Accordingly, the terminal devices 2 in the partial area A5 are provided with radio resources of 3.75 MHz in total. In other words, the partial area A5 requires the radio resources of 3.75 MHz in this time period.

The partial area A7 is covered by the cell A, the cell B, the cell C, and the cell E. Here, as illustrated in FIGS. 8 and 9, from 0:00 to 1:00 on March 7, the terminal devices 2 in the partial area A7 are provided with radio resources of 0.93 MHz from the cell A, are provided with radio resources of 1.25 MHz from the cell B, are provided with radio resources of 2.5 MHz from the cell C, and are provided with radio resources of 5.0 MHz from the cell E. Accordingly, the terminal devices 2 in the partial area A7 are provided with radio resources of 9.68 MHz in total. In other words, the partial area A7 requires the radio resources of 9.68 MHz in this time period.

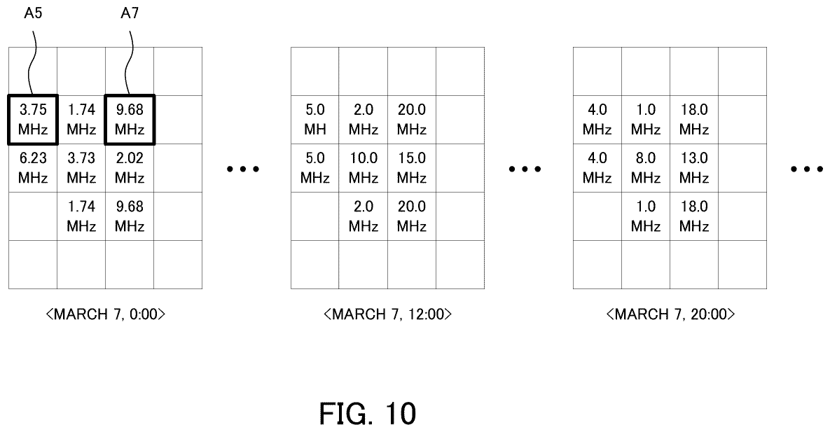

Similarly, as illustrated in FIG. 10, the total amount of radio resources to be provided is also calculated for other partial areas. In addition, the total amount of radio resources to be provided is also calculated for each partial area in other time periods. In the example illustrated in FIG. 10, the calculation result is denoted only for the partial areas A5 to A7, A9 to A11, A14, and A15 in the area of interest surrounded by the bold line in FIG. 3.

In this way, the communication management device 40 according to the embodiment calculates or predicts the total resource amount by adding the radio resource amount to be provided by each cell in consideration of superimposition of a plurality of cells for each of a plurality of partial areas obtained by dividing the designated area. Accordingly, with the use of this result, even in a case where a plurality of cells are formed to be superimposed on each other, it is possible to predict a position where traffic locally increases.

The communication management device 40 calculates the total amount of radio resources to be provided to the respective partial areas based on data collected periodically over a specified duration. Accordingly, it is possible to predict a position or an area where traffic increases in a specific time period or on a specific day of week, with excellent accuracy.

The communication management device 40 may control the base station system 10 based on this prediction. For example, when traffic in a certain partial area is predicted to temporarily decrease, the communication management device 40 may stop one or more of cells covering the partial area. By doing this, it is possible to reduce the power consumption of the base station system 10 while maintaining a quality of radio communication.

Alternatively, the communication management device 40 may suggest changing the configuration of the base station system 10 based on this prediction. For example, when traffic in a certain partial area is predicted to continuously increase, the communication management device 40 may suggest adding cells covering the partial area.

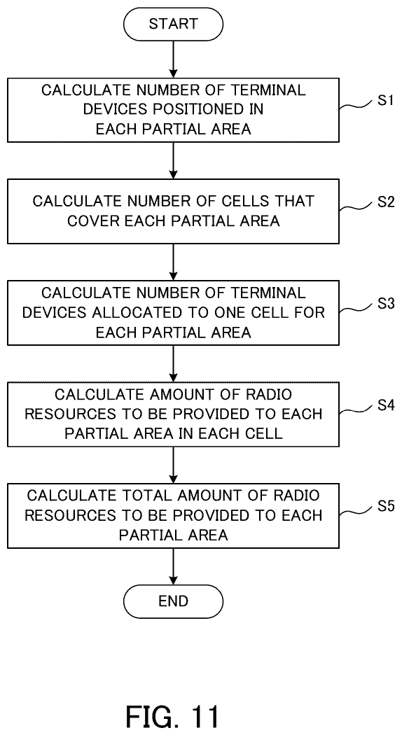

FIG. 11 is a flowchart illustrating an example of a radio resource prediction method according to the embodiment. A process of this flowchart is executed, for example, by the communication management device 40 illustrated in FIG. 2 according to an instruction from a user. In this example, it is assumed that the CM data, the PM data, and the position data described above are collected in a specified cycle over a specified duration, and are stored in a storage device of the communication management device 40.

In S1, the communication management device 40 calculates the number of terminal devices 2 positioned in each partial area based on the position data representing the positions of the terminal devices 2. The position data is not particularly limited, and is, for example, the MDT data. In S2, the communication management device 40 calculates the number of cells covering each partial area based on the CM data collected from the base station system 10. That is, the number of cells superimposed in each partial area is counted. In S3, the communication management device 40 calculates the number of terminal devices allocated to one cell for each partial area based on the calculation results of S1 and S2. In S4, the communication management device 40 calculates the amount of radio resources to be provided to each partial area in each cell based on the calculation result of S3 and the PM data (for example, the radio resource usage amount of each cell) collected from the base station system 10. In S5, the communication management device 40 calculates the total amount of the radio resources to be provided to the partial areas using the calculation result of S4. In this case, the total amount of the radio resources to be provided to the partial areas is calculated by adding the amount of radio resources to be provided by each cell for each partial area.

In this way, with the radio resource prediction method according to the embodiment, the total amount of the radio resources to be provided to the partial areas is calculated in consideration of superimposition of a plurality of cells. Accordingly, with the use of this result, even in a case where a plurality of cells are formed to be superimposed on each other, since it is possible to predict a position or an area where traffic locally increases or a position or an area where traffic locally decreases, it is possible to implement efficient cell design.

### Hardware Configuration

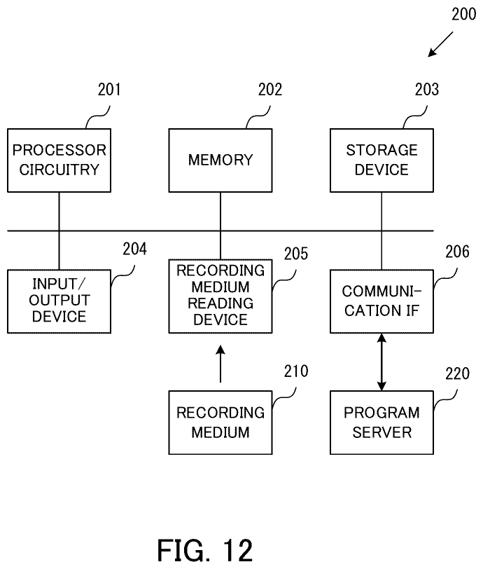

FIG. 12 illustrates an example of a hardware configuration of the communication management device 40. The communication management device 40 is implemented by a computer 200 including a processor circuitry 201, a memory 202, a storage device 203, an input/output device 204, a recording medium reading device 205, and a communication interface 206.

The processor circuitry 201 controls the operation of the communication management device 40 by executing a communication management program stored in the storage device 203. The communication management program includes a program code describing the procedure of the flowchart illustrated in FIG. 11. Accordingly, the functions of the UE position detector 61, the mesh-base number-of-UE calculator 62, the mesh-base number-of-cell calculator 63, the mesh/cell-base number-of-UE calculator 64, the cell-base resource calculator 65, and the mesh-base resource calculator 66 illustrated in FIG. 2 are provided by the processor circuitry 201 executing the program. The memory 202 is used as a work area of the processor circuitry 201. The storage device 203 stores the communication management program and other programs. Data collected by the data collection unit 50 is stored in the memory 202 or the storage device 203.

The input/output device 204 may include input devices such as a keyboard, a mouse, a touch panel, and a microphone. The input/output device 204 may include output devices such as a display device and a speaker. The recording medium reading device 205 can acquire data and information recorded in a recording medium 210. The recording medium 210 is a removable recording medium attachable and detachable to and from the computer 200. The recording medium 210 is implemented by, for example, a semiconductor memory, a medium that records a signal by an optical effect, or a medium that records a signal by a magnetic effect. The communication management program may be given from the recording medium 210 to the computer 200. The communication interface 206 provides a function for connection to a network. When the communication management program is stored in a program server 220, the computer 200 may acquire the communication management program from the program server 220.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present inventions have been described in detail, it should be understood that the various changes, substitutions, and alterations could be made hereto without departing from the spirit and scope of the invention.

What is claimed is:

1. A communication management device that is used in a radio communication system forming a plurality of cells, the communication management device comprising:
a processor circuitry configured to
calculate, for each of a plurality of partial areas obtained by dividing a designated area, the number of terminal devices positioned in the partial area to obtain a first calculation result,
calculate, for each of the plurality of partial areas, the number of cells covering the partial area to obtain a second calculation result,
calculate, for each of the plurality of partial areas, the number of terminal devices allocated to one cell based on the first calculation result and the second calculation result to obtain a third calculation result,
calculate, for each of the plurality of cells, an amount of radio resources to be provided to each partial area in the cell based on a usage amount of radio resources in the cell and the third calculation result to obtain a fourth calculation result, and
calculate, for each of the plurality of partial areas, an amount of radio resources to be provided to the partial area based on the amount of radio resources indicated by the fourth calculation result.

2. The communication management device according to claim 1, wherein
the processor circuitry calculates, for each partial area, the number of terminal devices allocated to one cell by dividing the first calculation result by the second calculation result.

3. The communication management device according to claim 1, wherein
the processor circuitry determines, for each cell, a proportion of radio resources allocated to each partial area in the cell based on the third calculation result, and
the processor circuitry calculates the amount of radio resources to be provided to each partial area in the cell by distributing the usage amount of the radio resources in the cell to the corresponding partial area according to the determined proportion.

4. The communication management device according to claim 1, wherein
the processor circuitry calculates, for each partial area, the amount of radio resources to be provided to the partial area by adding an amount of radio resources provided by cells covering the partial area.

5. The communication management device according to claim 1, wherein
the processor circuitry collects position data representing positions of terminal devices used in the radio communication system, and
the processor circuitry calculates the number of terminal devices positioned in each partial area based on the position data.

6. The communication management device according to claim 1, wherein
the processor circuitry collects configuration management data representing a configuration of a base station system of the radio communication system, and
the processor circuitry calculates the number of cells covering each partial area based on the configuration management data.

7. The communication management device according to claim 1, wherein
the processor circuitry collects performance management data representing performance of a base station system of the radio communication system, and
the processor circuitry detects the usage amount of the radio resources in each cell based on the performance management data.

8. A radio resource prediction method that predicts radio resources used in a radio communication system forming a plurality of cells, the radio resource prediction method comprising:
a first process of calculating, for each of a plurality of partial areas obtained by dividing a designated area, the number of terminal devices positioned in the partial area;
a second process of calculating, for each of the plurality of partial areas, the number of cells covering the partial area;
a third process of calculating, for each of the plurality of partial areas, the number of terminal devices allocated to one cell based on a calculation result of the first process and a calculation result of the second process;
a fourth process of calculating, for each of the plurality of cells, an amount of radio resources to be provided to each partial area in the cell based on a usage amount of radio resources in the cell and a calculation result of the third process; and
a fifth process of calculating, for each of the plurality of partial areas, an amount of radio resources to be provided to the partial area based on the amount of radio resources calculated by the fourth process.
